(19) United States
(12) Patent Application Publication
(10) Pub. No.: US 2016/0063119 A1
(43) Pub. Date: Mar. 3, 2016

(54) TEST DATA RESERVATION SYSTEM

(71) Applicant: Bank of America Corporation, Charlotte, NC (US)

(72) Inventors: Matthew J. Tevnan, Hillsborough, NJ (US); Michael Rass, Manalapan, NJ (US); Stanley Rass, Manalapan, NJ (US); Lauderdale S. Young, New Kensington, PA (US); Jonas B. Gottfried, Manalapan, NJ (US)

(21) Appl. No.: 14/476,218

(22) Filed: Sep. 3, 2014

(51) Int. Cl. G06F 17/30; G06Q 40/00; G06F 11/36

(52) U.S. Cl. CPC G06F 17/30867; G06F 17/3053; G06F 11/3692; G06F 11/3696; G06Q 40/125

(57) ABSTRACT

Systems and methods are provided for facilitating software testing. Test data available for testing computer program testing is stored at a data store. An individual may submit a reservation request for a portion of the test data. A reservation device may reserve the selected portion of the test data such that, while it is reserved, the test data is only modifiable during tests initiated by the individual that reserved it. Other individuals may be restricted from modifying test data they have not reserved. A test data search interface may be used to configure a search query for the test data. An estimated reservation duration may be received with a reservation request, and notifications may be provided when that duration has or is about to expire. The reserved test data may be released for subsequent reservation, or the reservation may be renewed upon receipt of a renewal request.

### BACKGROUND

Testing is an important phase of the software development life cycle. Testing enables programmers to identify errors and defects (i.e., “bugs”) in computer programs and software applications (i.e., “software”) currently under development. To simulate how the software would operate upon release, programmers often utilize test data as input to the software under test. During testing the software might modify, add to, or delete the test data. In order to assess the functionality of the software under test it is important to know what input is provided to the software under test as well as the expected output.

It will thus be appreciated that conflicts might arise where tests of different software utilize the same test data. A test performed for one software application may, for example, modify the test data utilized by another software application. As a result programmers may not be able to accurately and confidently assess the output of the software under test where there is the potential for other software to modify the test data.

Therefore improved techniques for software testing are needed.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

A first aspect of the present disclosure provides a reservation system for facilitating software testing. The reservation system may include a processing unit and a data store that stores a set of test data available for testing of a computer program. The reservation system may also include a memory that stores computer-readable instructions executable by the processing unit. The instructions, when executed, may cause the reservation system to receive a selection of a portion of the test data from a computing device operated by an individual. The instructions, when executed, may also cause the reservation system to reserve the selected portion of the test data such that, while that portion of the test data is reserved, it is only modifiable by the individual that reserved it and not a second individual.

A second aspect of the present disclosure provides a computer-implemented method for facilitating software testing. Test data available for the testing of a computer program is stored at a data store. A selection of a portion of that test data is received from a computing device operated by an individual. A reservation device may reserve the selected portion of the test data such that, while that portion of the test data is reserved, the reserved portion of the test data is only modifiable by the individual that reserved it and not by another individual.

The reservation device may permit modification of the test data during tests initiated by the individual that reserved it and restrict tests initiated by other individuals from modifying the test data. Test data may be reserved for an individual by associating the test data with a unique identifier of the individual that reserved it. Reservation records may be created that identify the test data an individual has reserved and the individual that reserved it.

The reservation device may provide a search interface having a set of search criteria available for selection. The reservation device may receive a search query that includes a selection of test data search criteria and retrieve test data records from a data store based on that search query. The reservation device may provide a search results interface that identifies the test data that matches the search query. The reservation device may then receive a reservation request that identifies a set of test data records selected for reservation. The reservation device may provide a reservation summary interface that includes a listing of the portion of the test data successfully reserved. Search queries may be stored and associated with the individual that submitted them for subsequent use.

An estimated reservation duration may also be received with the reservation request. A notification may be provided a predetermined amount of time prior to expiration of the reservation duration. Upon expiration of the reservation duration, the reserved test data may be automatically released such that the test data is subsequently reservable. The reservation of the reserved test data may also be renewed in response to receipt of a renewal request.

The test data available for reservation may be stored at a data store as respective test data records with corresponding attributes. The test data selected for reservation may thus be the test data records stored at the data store. The test data records may be financial account records and include attributes such as the testing environment, an account number, an account classification, an account feature, and an account balance.

The details of these and other embodiments of the disclosure are set forth in the accompanying drawings and description below. Other features and advantages of aspects of the disclosure will be apparent from the description, drawings, and claims.

### BRIEF DESCRIPTION OF THE DRAWINGS

Aspects of the disclosure may be implemented in certain parts, steps, and embodiments that will be described in detail in the following description and illustrated in the accompanying drawings in which like reference numerals indicate similar elements. It will be appreciated with the benefit of this disclosure that the steps illustrated in the accompanying figures may be performed in other than the recited order and that one or more of the steps disclosed may be optional. It will also be appreciated with the benefit of this disclosure that one or more components illustrated in the accompanying figures may be positioned in other than the disclosed arrangement and that one or more of the components illustrated may be optional.

FIG. 1 is an illustrative operating environment in which various aspects of the disclosure may be implemented.

FIG. 2 is a block diagram of an example of an implementation of a test data reservation system.

FIG. 3 is a block diagram of another example of an implementation of a test data reservation system.

FIG. 4 is a flowchart of example method steps for reserving test data.

FIG. 5 is an example of an implementation of a test data search interface.

FIG. 6 is an example of an implementation of a test data search results interface.

FIG. 7 is an example of an implementation of a reservation summary interface.

FIG. 8 is an example of an implementation of a user profile interface.

### DETAILED DESCRIPTION

Aspects of the present disclosure are directed toward reserving test data for software development testing. The test data reservation system maintains a pool of test data that is available for reservation when testing computer programs under development. Users may access the system and search for test data matching specified criteria. Users may reserve a set of test data from the test data search results. While the test data is reserved, only the individual that reserved the test data may modify that test data. Since only one testing session operates on the reserved test data at a given time, testers may be confident that the test results are valid and reliable. Once testing is complete, the testers may release the reserved test data for use during other testing sessions. The test data reservation system also allows testers to export reserved test data as well as identify sets of reserved test data by project, phase, application name, and so forth. These and additional benefits will be appreciated with the benefit of the disclosures discussed in further detail below.

It is also to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging. In addition, “set” as used in this description refers to a collection that may include one element or more than one element.

Moreover, aspects of the disclosure may be implemented in non-transitory computer-readable media having instructions stored thereon that, when executed by a processor, cause the processor to perform various steps described in further detail below. As used in this description, non-transitory computer-readable media refers to all computer-readable media with the sole exception being a transitory propagating signal. The instructions may be organized into one or more program modules that may be executed by one or more computers or other devices as described herein. Program modules may include routines, programs, objects, components, data structures, and the like that perform particular tasks or implement particular data types when executed by a processor in a computer or other device. The modules may be written in a source code programming language that is subsequently compiled for execution, or may be written in a scripting language that supports scripts interpreted in a run-time environment. The instructions may be stored on a computer-readable medium as described in further detail below. Accordingly aspects of the disclosure may be embodied as a method, data processing system, or computer program product. Functionality described below may therefore be embodied at least in part in software, firmware, or hardware such as integrated circuits, field programmable gate arrays (FPGA), and the like. Furthermore data structures that implement aspects of the disclosure are considered to be within the scope of the computer-readable instructions.

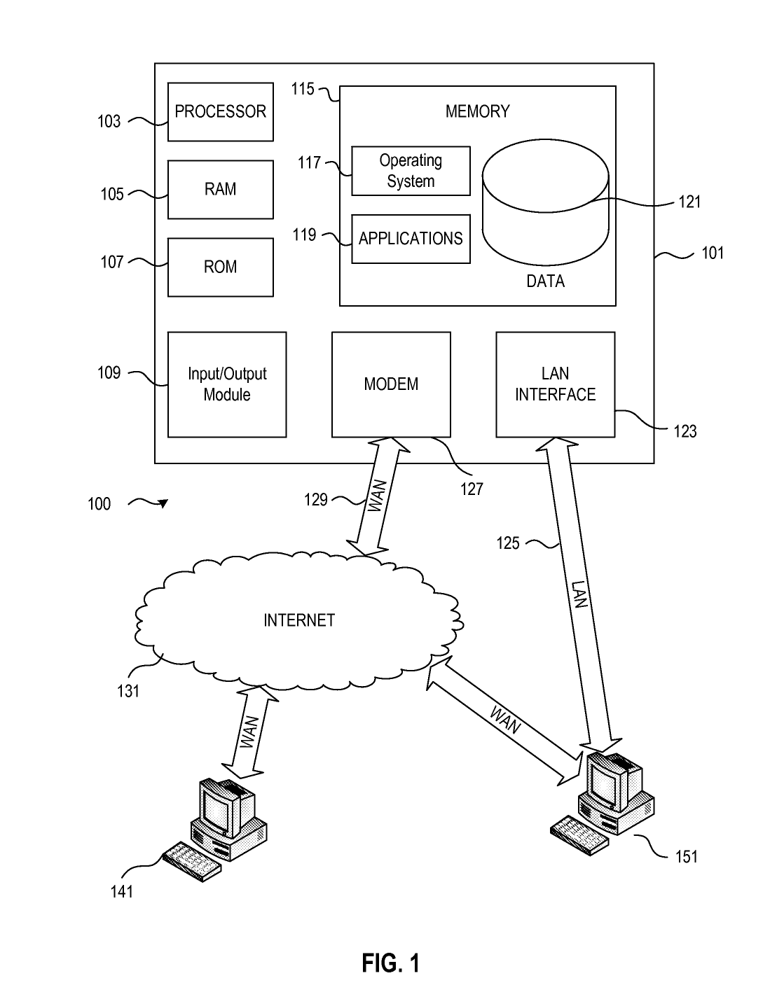

FIG. 1 illustrates an example of an example of an implementation of a test data reservation system 100 that may be used according to one or more illustrative embodiments. The test data reservation system 100 is only one example of a test data reservation system and is not intended to suggest any limitation as to the scope of use or functionality contained in the disclosure. The test data reservation system should not be interpreted as having any dependency or requirement relating to any one or combination of components shown in the illustrative test data reservation system 100.

The disclosure is operational within a special purpose computing systems and environments configured to reserve test data for software development testing. These special purpose computing systems and environments may include personal computers (PCs), server computers, hand-held or laptop devices, multiprocessor systems, microprocessor-based systems, programmable consumer electronics, network PCs, minicomputers, mainframe computers, distributed computing environments that include any of the systems or devices listed above, and the like.

With reference to FIG. 1, the test data reservation system 100 may include a test data reservation device 101 at which aspects of the disclosure may be implemented. The test data reservation device 101 may have a processor 103 for controlling the its overall operation and its associated components which may include random-access memory (RAM) 105, read-only memory (ROM) 107, a communications module 109, and memory 115. The processor 103 and its associated components may allow the test data reservation device 101 to run a series of computer-readable instructions related to reserving test data for software development testing.

The test data reservation device 101 may include a variety of computer-readable media. The computer-readable media may be any available non-transitory media that may be accessed by test data reservation device 101 and may include both volatile and non-volatile media as well as removable and non-removable media.

Computer storage media include volatile and non-volatile, removable and non-removable media implemented in any method or technology for storage of information such as computer-readable instructions, data structures, program modules, or other data. Computer storage media include, but are not limited to, random access memory (RAM), read-only memory (ROM), electronically erasable programmable read only memory (EEPROM), flash memory or other memory technology, CD-ROM discs, digital versatile discs (DVD), or other optical disk storage, magnetic cassettes, magnetic tape, magnetic disk storage or other magnetic storage devices, or any other non-transitory medium that can be used to store the desired information that can be accessed by the test data reservation device 101.

The test data reservation system 100 may also include optical scanners (not shown). Example uses of the optical scanners include scanning and converting paper documents, such as correspondence, data, and the like to digital files.

Although not shown, RAM 105 may include one or more applications representing the application data stored in RAM 105 while the test data reservation system 101 is running and while corresponding software applications (e.g., software tasks) are executing on the test data reservation device 101.

The communications module 109 may include a microphone, keypad, touch screen, stylus, or other types of input devices through which a user of the test data reservation system 101 may provide input, and may also include one or more of a speaker for providing audio output and a video display device for providing textual, audiovisual, and/or graphical output.

Software may be stored within memory 115 and/or a storage device or storage media to provide instructions to the processor 103 that enable the test data reservation device 101 to perform various functions. For example, memory 115 may store software used by the test data reservation device 101, such as an operating system 117, application programs 119, and an associated database 121. In certain aspects, the test data reservation device 101 may comprise a plurality of databases 121. Also, some or all of the computer executable instructions for the test data reservation device 101 may be embodied in hardware or firmware.

The test data reservation device 101 may operate in a networked environment supporting connections to one or more remote computing devices, such as computing devices 141 and 151. The computing devices 141 and 151 may be personal computing devices or servers that include many or all of the elements described above relative to the test data reservation device 101.

The network connections depicted in FIG. 1 may include a local area network (LAN) 125 and a wide area network (WAN) 129, but may also include other types of networks. When used in a LAN networking environment, the test data reservation device 101 may be connected to the LAN 125 through a network interface or adapter in the communications module 109. When used in a WAN networking environment, the test data reservation device 101 may include a modem in the communications module 109 or other means for establishing communications over the WAN 129, which may include the Internet 131 or other type of wide-area computer network. It will be appreciated that the network connections shown are illustrative and other means of establishing a communication link between the computing devices may be used. Various well-known protocols such as TCP/IP, Ethernet, FTP, HTTP, and the like may be used. The test data reservation device 101 may be operated in a client-server configuration to permit a user to retrieve web pages from a web-based server. Any of various conventional web browsers may be used to display and manipulate web pages.

Additionally, one or more application programs 119 used by the test data reservation device 101, according to an illustrative embodiment, may include computer-executable instructions for invoking functionality related to communication including, for example, email, short message service (SMS), and voice input and speech recognition applications. In addition, the application programs 119 may include computer-executable instructions for invoking user functionality related to access a centralized repository for performing various service tasks like routing, logging, data storage, and protocol bridging. The application programs 119 may further include applications for searching test data available for reservation, processing test data reservation requests, providing notifications regarding reserved test data, renewing reservations of test data, releasing reserved test data, and refreshing the pool of test data available for reservation.

Embodiments of the disclosure may include forms of computer-readable media. Computer-readable media include any non-transitory media that can be accessed by the test data reservation device 101. Storage media include volatile and nonvolatile, removable and non-removable media implemented in any method or technology for storage of information such as computer-readable instructions, object code, data structures, program modules, or other data.

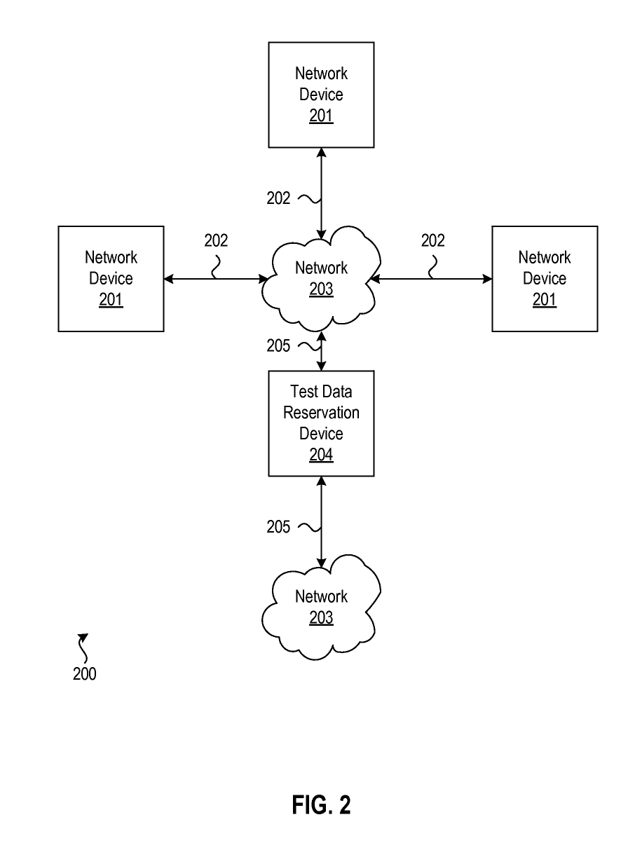

Referring now to FIG. 2, a block diagram of an example of an implementation of a test data reservation system 200 is shown. As illustrated, the test data reservation system 200 may include one or more network devices 201 which may, in some examples, be connected by one or more communication links 202 to computer network 203. The computer network 203 may in turn be linked via communication links 205 to the test data reservation device 204. In the test data reservation system 200, the test data reservation device 204 may be any suitable server, processor, computer, or data processing device, or combination of the same. In some example implementations the test data reservation device 204 of FIG. 2 may be the same as or at least similar to the test data reservation device 101 described above with reference to FIG. 1. The test data reservation device 204 may be used to process input received from a user or one or more of the network devices 201. As described in further detail below, the test data reservation device 204 may generate and transmit various signals to the network devices 201 via the communication links 202 and 205. The test data reservation device 204 may also receive and process various signals from the network devices 201 via the communication links 202 and 205. The signals generated and processed by the test data reservation device 204 may correspond to communications between the test data reservation device 204 and the network devices 201. Furthermore the test data reservation device 204 may perform various steps in response to and based on the signals received from the network devices 201.

The computer network 203 may be any suitable computer network including the Internet, an intranet, a wide-area network (WAN), a local-area network (LAN), a wireless network, a digital subscriber line (DSL) network, a frame relay network, and asynchronous transfer mode network, a virtual private network (VPN), or any combination of any of the same. The communication links 202 and 205 may be any communication links suitable for communicating between the network devices 201 and the test data reservation device 204, such as network links, dial-up links, wireless links, hard-wired links, and the like.

Having described examples of computing devices that may be used to implement various aspects of the disclosure and an operating environment in which various aspects of the disclosure may be implemented, various embodiments are discussed in greater detail below.

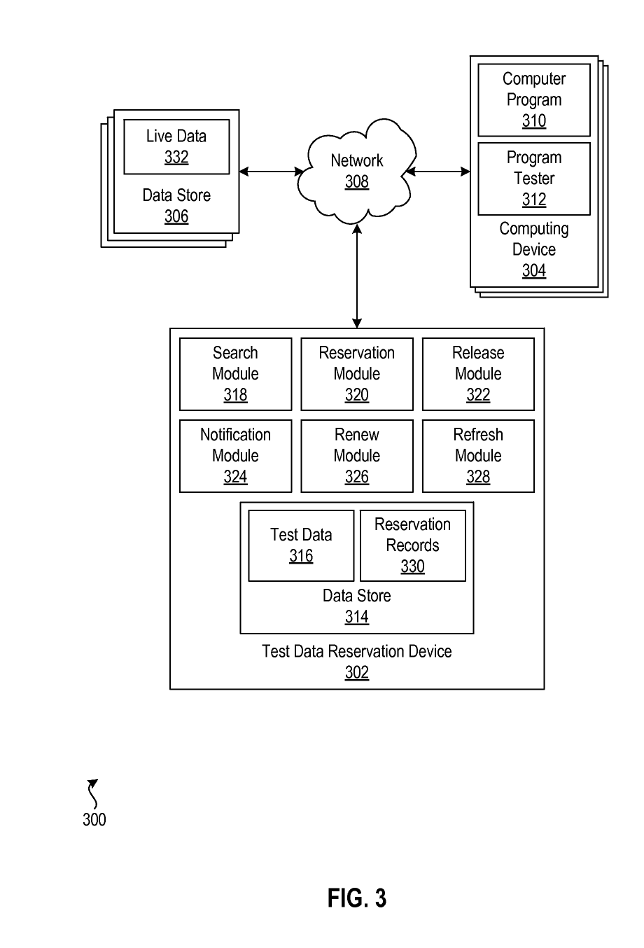

Referring now to FIG. 3, another example of an implementation of a test data reservation system 300 is shown. The test data reservation system 300 may be similar to and include one or more of the components of the test data reservation systems 100 and 200 respectively described above with reference to FIGS. 1-2. The test data reservation system 300 similarly includes a test data reservation device 302, which may be similar to and include one or more components of the test data reservation devices 101 and 204 also described above with reference to FIGS. 1-2. The test data reservation device 302 may be in signal communication with one or more computing devices 304 and one or more data stores 306 via a network 308. The computing devices 304 may be similar to and include one or more of the components of the network devices 201 described above with reference to FIG. 2. In addition, the test data reservation device 302, in this example, is shown to be in signal communication with a computing device 304 and a data store 306 that are each located remotely relative to the test data reservation device. In other example implementations, however, computing devices and data stores may be additionally or alternatively located locally relative to the test data reservation device 302.

The computing device 304, in this example, includes a computer program 310 and a program tester 312. As used in this description, computer program includes software applications, functions, modules, scripts, libraries, and any other set of instructions that may be executed at a processing unit. As used in this description, a processing unit may include one or more processors operating individually or in parallel. The computer program 310 may be a computer program currently under development, and the program tester 312 may be configured to test the functionality of the computer program. The program tester 312 may be any commercially-available or proprietary computer program, software application, script, module, plug-in, add-on, and the like suitable for testing the functionality of the computer program 310. The program tester 312 may be utilized to test the functionality of the computer program multiple times throughout the development process. Such testing may include one or more of unit testing, integration testing, system testing, acceptance testing, and other types of testing used to test the functionality and operation of software applications, computer programs, and the like.

The test data reservation device 302 may facilitate the testing of the computer program 310 by providing test data to use during the tests. To facilitate testing, the test data reservation device 302, in this example, includes; a data store 314 that stores a set of test data 316 available for reservation; a search module 318 configured to facilitate test data search requests; a reservation module 320 configure to facilitate test data reservations; a release module 322 configured to facilitate the release of reserved test data; a notification module 324 configured to facilitate providing notifications regarding reserved test data; a renew module 326 configured to facilitate test data reservation renewals; and a refresh module 328 configured to facilitate a refresh of the test data available for reservation.

The data store 314 may store the test data 316 available for reservation. The data store 314 may be a database that stores the test data 316 as individual electronic test data records. Accordingly the test data records may include various columns corresponding to attributes of the test data including, e.g., a unique identifier. The database may also include a database management system (not shown) that handles creating, updating, and retrieving test data records when searching for test data records, reserving test data records, and refreshing the test data 316.

Financial institutions are one example of an institution that may implement a test data reservation system to improve testing of its software. It will therefore be recognized that much of the software developed for a financial institution may be directed toward the various financial accounts maintained by that financial institution, e.g., checking accounts, savings accounts, investment accounts, and the like. In turn, the test data 316 stored for a test data reservation system of a financial institution may include data corresponding to the details and attributes associated with financial accounts. The test data reservation systems implemented by other types of institutions may include additional and alternative types of data.

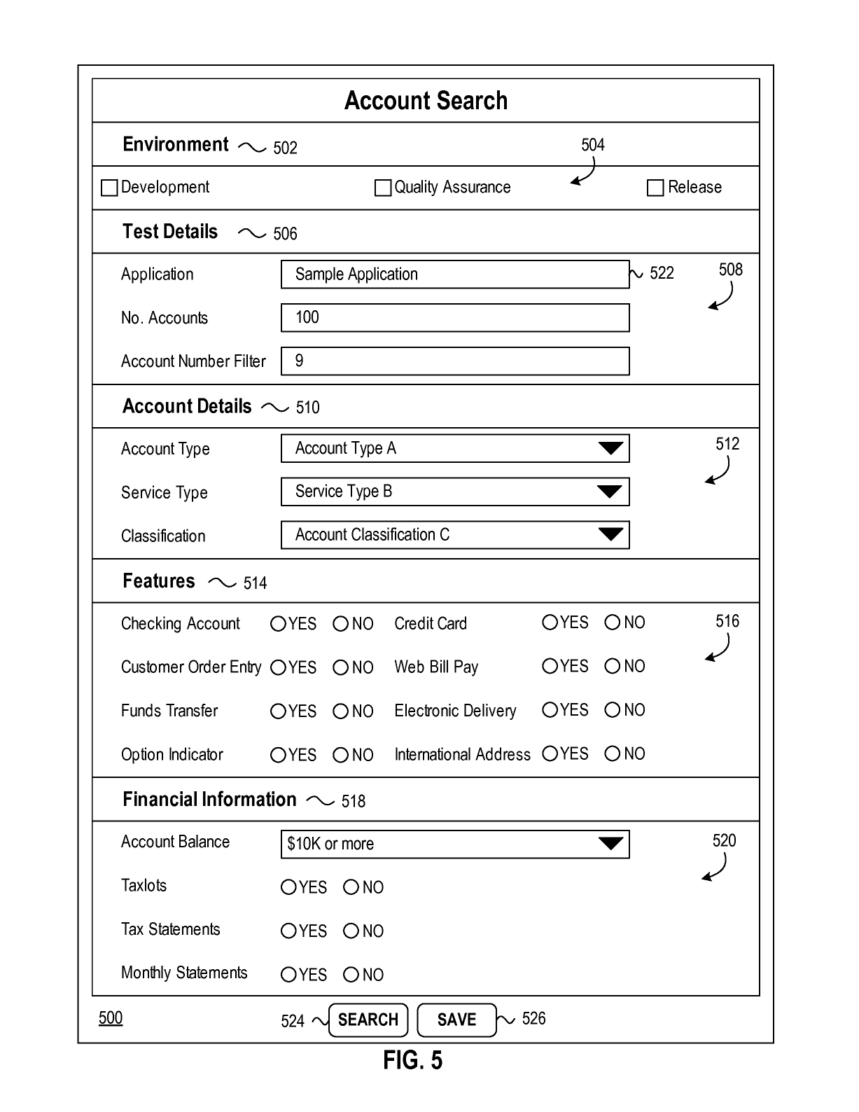

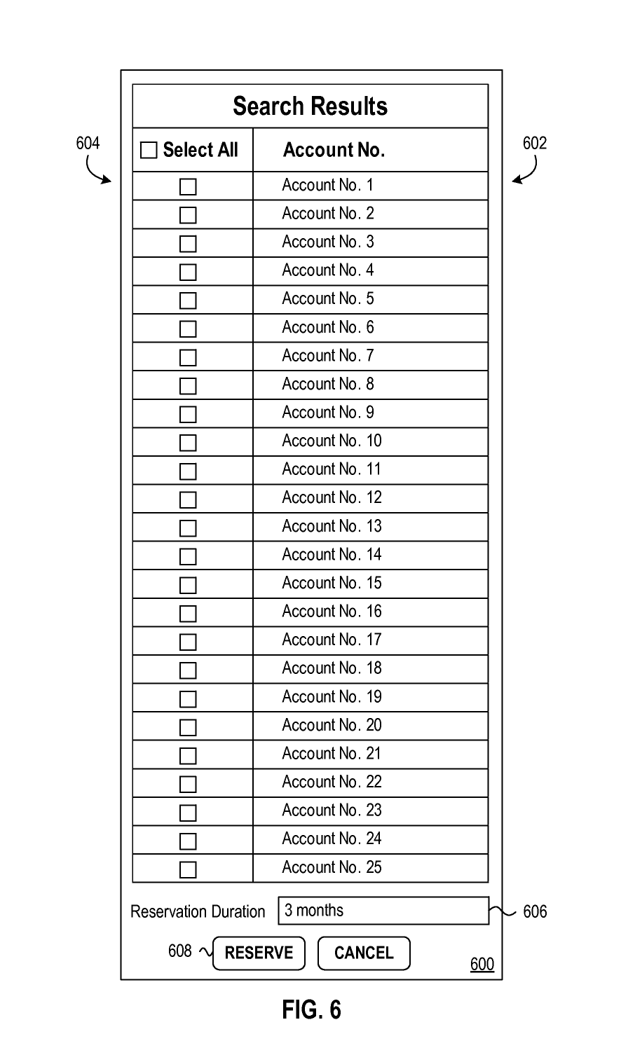

The search module 318 may be configured to facilitate test data search requests. The search module 318 may, for example, provide a search interface to the computing device 304. The search interface may include various search criteria available for selection by a user operating the computing device 304. The search interface may also include various user interface elements for receiving selections of the search criteria from the user. The user interface elements may include, for example, checkboxes, combo boxes, drop-down lists, list boxes, radio buttons, and text boxes. The search module 318 may provide the search interface to the computing device 304 as, for example, a web page, and a web browser at the computing device may display the search interface to the user. The user may select the desired test data search criteria and the search interface, and the web browser may submit the selected search criteria to the test data reservation device 302 in an HTTP POST request. Upon receipt of the selected search criteria, the search module 318 may query the data store 314 for test data 316 that matches that search criteria and provide the matching test data to the search module. In some example implementations, the query the search module 318 submits to the data store 314 may be configured to exclude test data 316 that has already been reserved. In other example implementations, the search module 318 may be configured to filter from the search results any test data 316 that has already been reserved. The search module 318 may then provide the test data 316 that matches the selected search criteria to the computing device 304, e.g., in an HTTP response. The search module 318 may provide a search results interface that includes the test data 316 to the computing device 304. The search results interface may list the test data 316 that matches the search criteria include interface elements for selecting at least a portion of the test data 316 to reserve. The search results interface may also be implemented as a web page. Example implementations of a search interface and a search results interface are respectively illustrated in FIG. 5 and FIG. 6.

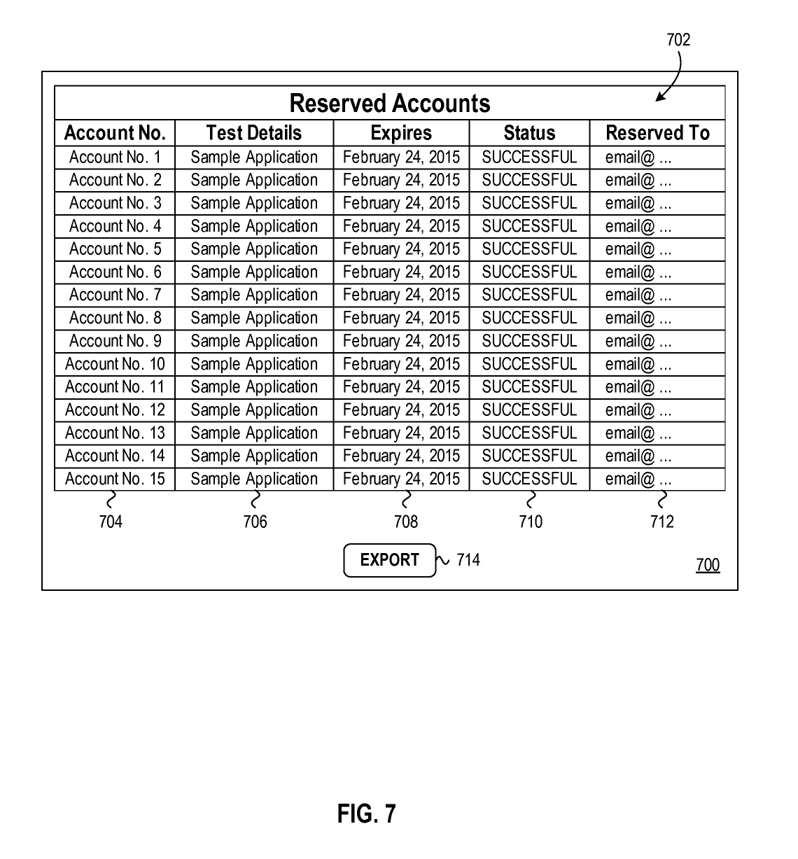

The reservation module 320 may be configured to facilitate the reservation of test data. The user may select the test data 316 to reserve at the search results interface, and the computing device 304 may provide a reservation request to the test data reservation device 302, e.g., in and HTTP request. The reservation request may identify the test data selected for reservation, e.g., via the unique identifier of the test data record. As described in further detail below, the reservation request may include a reservation duration. The reservation duration may indicate an amount of time the user expects to need the reserved test data, e.g., one week, three months, and so forth. The reservation duration may additionally or alternatively indicate a date that the user needs the reserved test data at which point the reservation may expire. The reservation module 320 may process the reservation request received in order to reserve the selected test data 316. The reservation module 320 may reserve the selected test data 316 by establishing an association between the test data and the user that requested reservation of the test data. Various techniques may be selectively employed to establish an association between the test data 316 and the user requesting reservation of the test data. In one example implementation, the reservation module 320 may reserve the selected test data 316 for a user by updating test data records to include a unique identifier associated with the user such as, e.g., a user ID number or an email address. In another example implementation, the reservation module 320 may reserve the selected test data 316 for a user by creating and storing reservation records 330 at the data store 314. A reservation record 330 may establish a relationship between a test data record and a user record using unique identifiers of the test data record and the user record. A reservation record 330 may also include information indicating the date and/or time the user requested reservation of the selected test data 316, a unique identifier for the reservation record, and the reservation duration included in the reservation request. In this way, the test data reservation device 302 may advantageously determine whether the reservation is about to expire or has expired. Upon completing the reservation, the reservation module 320 may prepare a reservation confirmation and provide the reservation confirmation to the computing device 304. The reservation confirmation may identify the test data 316 that has been successfully reserved. The reservation module 320 may provide the reservation confirmation as a reservation confirmation web page (e.g., in an HTTP response). An example reservation confirmation web page is illustrated in FIG. 7.

When test data 316 has been reserved, the test data may only be modified by tests initiated by the user that has reserved that portion of the test data. In other words, tests initiated by users that have not reserved that portion of the test data 316—i.e., users that are not associated with the test data—may be unable to and actively prevented from modifying that reserved test data. In this way, the test data reservation system 300 advantageously preserves the integrity of the reserved test data 316 utilized for software development testing. Users performing software tests with reserved test data 316 may advantageously avoid unexpected modifications to the test data from software tests performed by other users. In turn, the validity of the output resulting from the software rests is therefore preserved. It will also be recognized that the test data reservation device 302 provides a centralized repository of test data 316 accessible to multiple development teams. As a result, the test data reservation device 302 advantageously eliminates or at least reduces the need for multiple software development teams to maintain their own individual repositories of test data thereby improving the efficiency of the operating environment in which software is developed and tested. Additional advantages will be appreciated with the benefit of this disclosure.

The release module 322 of the test data reservation device 302 may be configured to release (i.e., “un-reserve”) test data 316 after it has been reserved for a user. The release module 322 may be configured to automatically release reserved test data 316 or release reserved test data in response to a release request received from the computing device 304. The release module 322 may automatically release reserved test data 316 in response to determining that the reservation duration for the reserved test data has expired. Accordingly the release module 322 may be configured to periodically query (e.g., daily) the data store 314 for the reservation durations associated with reserved test data 316, compare the reservation duration to the current date, and release the test data having reservation durations that have expired. The release module 322 may be configured to release the reserved test data 316, e.g., by deleting the unique identifier (e.g., the email address) stored in the test data records that associates the test data record with the user that requested the reservation or by deleting the reservation records that establish a relationship between the test data records and the user record for the user that requested the reservation. The reservation duration may only be an estimate of the timeframe a user expects to need the reserved test data 316. Those skilled in the art of software development that delays and hiatuses in the software development process may extend the need for the test data reservation. Therefore, in some example implementations, the release module 322 may be configured to only release reserved test data 316 in response to receipt of a release request. In these example implementations, the test data reservation device 302 may instead simply provide a notification to the user that the reservation is about to or has expired as discussed in further detail below.

The release request may identify the test data 316 itself (e.g., via a unique identifier) in which case the release module 322 may only release the test data identified in the release request. The release request may additionally or alternatively identify one or more reservation records (e.g., via a unique identifier) in which case the release module 322 may only release reserved test data 316 that is associated with the reservation records identified in the release request. The release request may also additionally or alternatively identify the user (e.g., via a unique identifier) in which case the release module 322 may only release reserved test data 316 that is associated with the user identified in the release request. Additional and alternative techniques for releasing the reserved test data may be selectively employed.

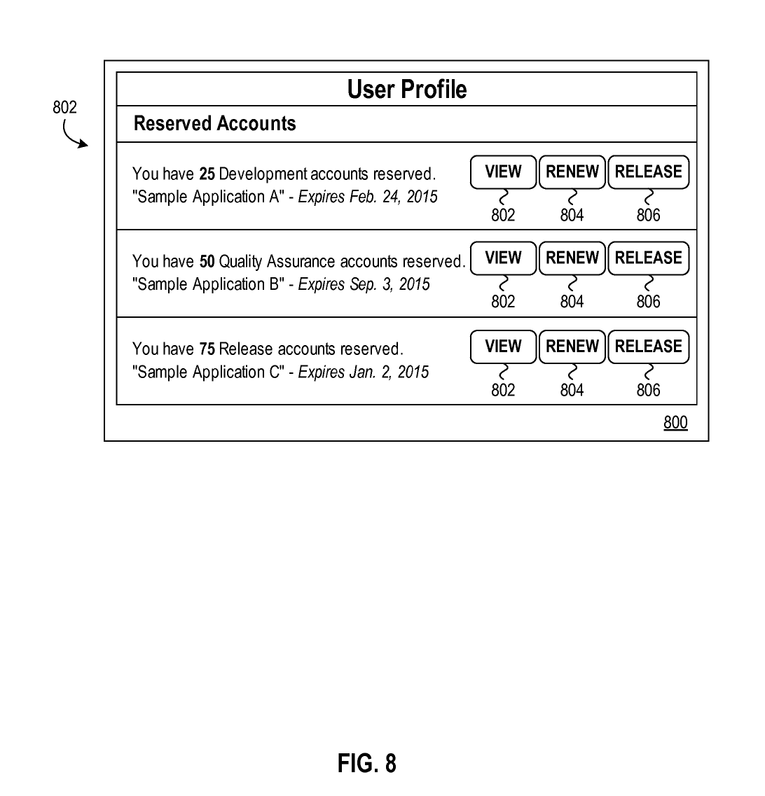

The notification module 324 may be configured to facilitate providing notifications regarding the reserved test data 316. Notifications may include notifications identifying portions of test data 316 reserved by a user, notifications indicating that a reservation is about to expire, notifications indicating that a reservation has expired, and other types of notifications that provide a user with information regarding the reserved test data. The notification module 324 may provide notifications to the computing device 304. Accordingly the notification module 324 may provide notifications as web pages, email messages, instant messages, text messages, and the like. Similar to the release module 322 described above, the notification module 324 may periodically query the data store 314 for reservation durations that are about to expire (e.g., within a day, a week, and so forth) or that have already expired. The notification module may then prepare expiration notifications to the users that have reserved that test data 316 which may request those users either release or renew the reservation. Renewing reservations is discussed in further detail below. In one example implementation, the notification module 324 may be configured to provide the computing device 304 with a user profile web page (e.g., in an HTTP response) that is associated with a user that has reserved test data 316 using the test data reservation device 302. The user profile web page may include, e.g., a listing of one or more portions of the test data 316 the user has reserved. An example user profile web page is illustrated in FIG. 8.

The renew module 326 may be configured to facilitate the renewal of test data reservations. The renew module 326 may renew a test data reservation in response to receipt of a renew request from the computing device 304 (e.g., in an HTTP request). In some example implementations, the renew module 326 may be configured to extend the reservation of the test data by a predetermined amount of time (e.g., a week, a month, and so forth) in response to receipt of a renewal request. In other example implementations, the renewal request may include another reservation duration specified by the user. Upon receipt of the renewal request, the renew module 326 may update the test data records or the reservation records 330 stored in the data store 314. The renewal request may identify the test data 316 itself (e.g., via a unique identifier) in which case the renew module 326 may only renew the test data identified in the renewal request. The renewal request may additionally or alternatively identify one or more reservation records (e.g., via a unique identifier) in which case the renew module 326 may only renew reserved test data 316 that is associated with the reservation records identified in the renewal request. The release request may also additionally or alternatively identify the user (e.g., via a unique identifier) in which case the release module 322 may only release reserved test data 316 that is associated with the user identified in the renewal request. Additional and alternative implementations for releasing reserved test data may be selectively employed.

The refresh module 328 may be configured to facilitate a refresh of the test data 316 available for reservation. Real-world data may provide relatively more valid and accurate test results. Accordingly, the refresh module 328 may refresh the pool of test data 316 by data mining one or more data stores 306 that store live data 332. During a refresh of the test data 316, the refresh module 328 may retrieve portions of the live data 332 from the data stores 306 and copy the live data to the data store 314 of the test data reservation device 302 as test data 316. To preserve any confidential information associated with the live data, the refresh module 328 may filter any information that identifies real-world individuals or includes any potentially sensitive content before saving the data to the data store 314 as test data 316. The refresh module 328 may refresh the pool of test data 316 periodically (e.g., weekly, monthly, quarterly, and so forth) or on-demand in response to receipt of an instruction from, e.g., an administrator.

It will be recognized that the test data reservation system 300 and the test data reservation device 302 are described with reference to FIG. 3 by way of example only. Other implementations of a test data reservation system may include additional and alternative components. Similarly other implementations of a test data reservation device may include additional or alternative modules that provide additional and alternative functionality associated with reserving test data.

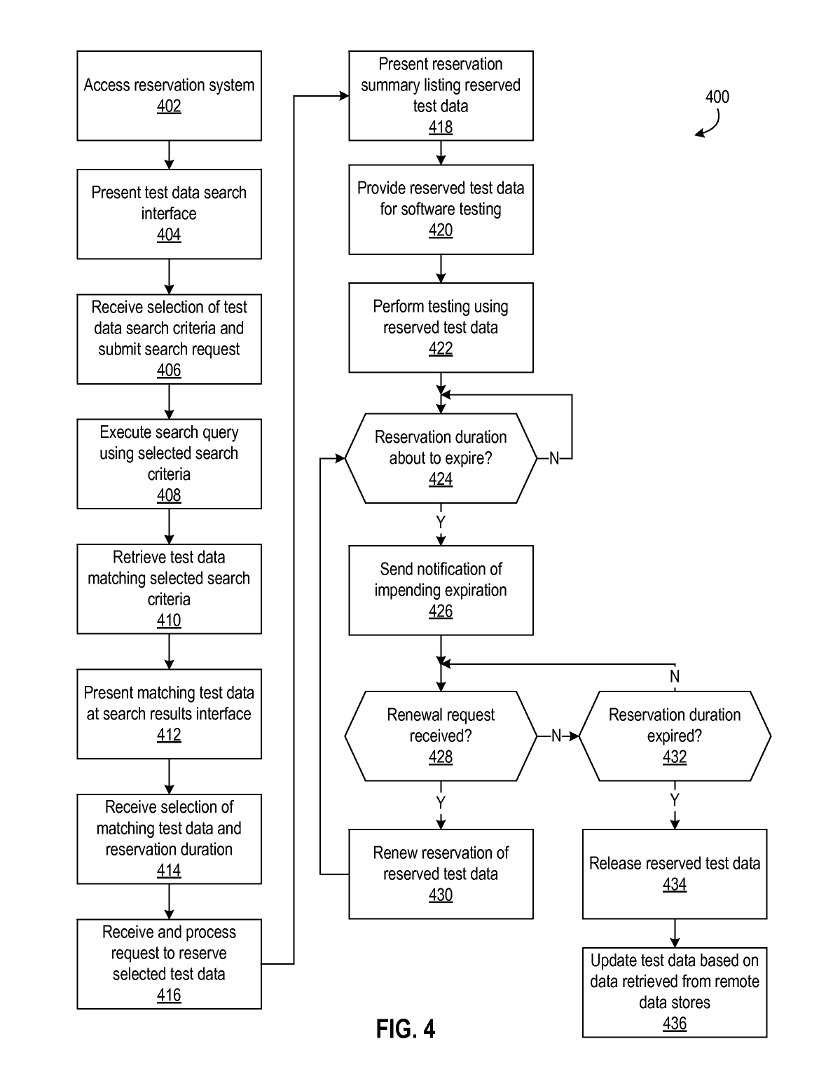

Referring now to FIG. 4, a flowchart 400 of example method steps for reserving test data is shown. A user may access the test data reservation system (block 402), e.g., by navigating to a URL address using a web browser. The test data reservation system may provide an initial login interface to the user, and the user may provide login credentials (e.g., a username and password) to obtain access to the system. The test data reservation system may subsequently utilize the login credentials to identify the user when reserving test data. Upon successful login, a test data search interface may be presented to the user (block 404) which may include search criteria for the test data as described above. User selections of test data search criteria may be received at the search interface and a search request may be submitted to the test data reservation system (block 406). The test data reservation system may execute the search query using the selected search criteria (block 408) and retrieve test data matching the selected search criteria from the data store (block 410). The test data reservation system may then provide the search results for presentation to the user at a search results interface (block 412).

Upon receipt of the search results, the user may select some or all of the test data matching the selected search criteria for reservation (block 414) and submit a reservation request identifying the selected test data. The user may also indicate a desired reservation duration which may also be included in the reservation request. The test data reservation system may receive and process the reservation request to reserve the selected test data for the specified reservation duration (block 416). Upon successful reservation, the test data reservation system may prepare a reservation summary listing the test data successfully reserved (block 418) for presentation to the user as described above. Having reserved the test data, the use may then retrieve the reserved test data from the data store (block 420) for use with software testing. Retrieving the test data may include accessing the reserved test data stored in the data store directly from software under test during testing activities or, additionally or alternatively, exporting the reserved test data for use during testing activities. Reserved test data may be exported as, e.g., a spreadsheet or a delimited text file. Additional and alternative approaches to exporting the test data may be selectively employed. Having retrieved the reserved test data, the user may perform software testing using the reserved test data (block 422) as described above.

If the user specified a duration for the reservation when reserving the test data, the test data reservation system may determine whether that reservation is about to expire. If the reservation has not yet expired (block 424:N), then the test data reservation system may periodically check the status of the reservation duration as described above. If the reservation is about to expire (block 424:Y), then the test data reservation system may notify the user of the impending expiration of the reservation (block 426). The test data reservation system may, for example, send the notification as an email to an email address associated with the user that reserved the test data. The email may include, for example, a link that submits a renew request to the test data reservation system upon selection. If the test data reservation system receives a renewal request (block 428:Y), the test data reservation system may renew the reservation of the test data (block 430) and monitor the reservation for impending expiration as described above. If the test data reservation system does not receive a renewal request (block 428:N), then the system may determine whether the reservation has expired. If the reservation has not yet expired (block 432:N), the test data reservation system may continue to monitor the reservation for expiration as also described above. If, however, the reservation has expired (block 432:Y), then the test data reservation system may automatically release the reserved test data (block 434). As noted above, some example implementations of the test data reservation system may send another notification to the user indicating that the reservation has expired instead of automatically releasing the test data. Other example implementations of the test data reservation system may notify the user that the test data will be released in a predetermined amount of time (e.g., 5 days) unless the user renews the reservation. The test data reservation system, in this example, may then automatically release the reserved test data if the user does not submit a renewal request within that timeframe. Finally, the test data reservation system may periodically update the test data stored in the data store by retrieving data (e.g., live data) from one or more remote data stores (block 436) as described above and storing the updated test data at the data store.

Referring now to FIGS. 5-8, various example implementations of interfaces a test data reservation system may provide are shown. The interfaces shown by way of example in FIGS. 5-8 may be employed where the test data available for reservation includes data associated with financial accounts maintained by a financial institution. These interfaces may include various interface elements for presenting information to the user and receiving input from the user. The various interfaces described below with reference to FIGS. 5-8 may include additional and alternative interface elements and present additional and alternative information associated with test data and test data reservations.

In FIG. 5, an example of an implementation of a test data search interface 500 is shown. As described above, the test data search interface 500 presents search criteria a user may select to locate desired test data. As seen in FIG. 5, the test data search interface 500 includes multiple sections for various categories of search criteria. In particular the test data search interface 500, in this example, includes: a section for search criteria 502 related to the operating environment for the software under test and input elements 504 for selecting that search criteria; a section for search criteria 506 related to the search result preferences and input elements 508 for selecting that search criteria; a section for search criteria 510 related to financial account details and input elements 512 for selecting that search criteria; a section for search criteria 514 related to financial account features and input elements 516 for selecting that search criteria; and a section for search criteria 518 related to the financial information associated with the account and input elements 520 for selecting that search criteria. As seen in FIG. 5, the input elements for selecting or otherwise specifying search criteria for the test data include, in this example, checkboxes, text boxes, drop-down menus, and radio buttons. Other implementations of the test data reservation system may include additional and alternative combinations of search criteria.

The search criteria 502 for the operating environment may enable the user to search for test data suitable for use with software operating in one or more of a development environment, a quality assurance environment, or a release environment. The search criteria 506 related to search result preferences may enable the user to limit the total number of search results returned (e.g., 100 total search results) and an account number filter. Some types of accounts may be delineated by one or more digits of the account number. Accordingly a user may specify an account number filter to either include or exclude test data associated with financial accounts that include the specified account number filter. The section for the search criteria 506 may also include an input element 522 for identifying the software the test data is to be reserved for. The identifier received at the input element 522 may also be used to label the search query as well as the portion of the test data selected for reservation from the search results. The search criteria 510 related to account details may include search criteria for the account type, account service type, and account classification. The search criteria 514 related to account features may enable a user to specify whether the test data retrieved should be associated with accounts having various features such as those illustrated at the example test data search interface 500 of FIG. 5. The search criteria 518 related to account financial information may enable the user to specify a minimum account balance and other finance-related search criteria.

The test data search interface 500, in this example, includes a “search” button 524 the user may select to submit the search query to the test data reservation system. The test data search interface 500, in this example, also includes a “save” button 526 to save the search query for future use. The test data reservation system may associate saved search queries with the user profile of the user that save the search request. The test data reservation system may include a list of saved search queries at, for example, the test data search interface presented to the user upon login. The user may select one of the saved search queries to resubmit the selected search query to the test data reservation system with the same search criteria previously selected.

In FIG. 6, an example of an implementation of a test data search results interface 600 is shown. The test data search results interface 600, in this example, includes a list 602 of accounts having test data that match the search criteria submitted by the user. The test data search results interface 600 also includes respective input elements 604 (e.g., checkboxes) for selecting desired accounts. As seen in FIG. 6, the test data search results interface 600, in this example, allows the user to select accounts individually or all at once. The test data search results interface, in this example, also includes an input element 606 that allows a user to specify the reservation duration which may be a timeframe (e.g., x number of weeks, months, and so forth) or a specific date. Having selected the desired accounts, the user may select a “reserve” button 608 to submit a reservation request. In response to receipt of the reservation request, the test data reservation system may reserve the test data associated with the selected accounts as described above. Other implementations of the test data search results interface may include additional or alternative information, buttons, and/or input elements.

In FIG. 7, an example of an implementation of a reservation summary interface 700 is shown. The reservation summary interface 700, in this example, includes a list 702 of the accounts having test data successfully reserved by the test data reservation system. The reservation summary interface 700, in this example, identifies for each successfully reserved account the account number 704, the test identifier 706, the reservation duration 708, the reservation status 710, and the user identifier 712 for the user the test data has been reserved to. The reservation summary interface 700, in this example, also includes an “export” button 714 that allows the user to export the reserved test data associated with the selected accounts. Selecting the “export” button 714 may allow the user to download a file (e.g., a spreadsheet file, delimited text file, and so forth) that includes the reserved test data. Other implementations of the reservation summary interface may include additional or alternative information, buttons, and/or input elements.

In FIG. 8, an example of an implementation of a user profile interface 800 is shown. As seen in FIG. 8, the user profile interface includes a list 802 of the sets of test data a user has reserved. For each set of test data reserved, the user profile interface 800, in this example, includes a “view” button 804, a “renew” button 806, and a “release” button. Selecting the “view” button 804 may allow the user to view the corresponding reserved test data, e.g., in an interface similar to the reservation summary interface described above with reference to FIG. 7. Selecting the “renew” button 806 may submit a renewal request for the corresponding reserved test data as described above. Selecting the “release” button 808 may submit a release request as also described above. Other implementations of the user profile interface may include additional or alternative information, buttons, and/or input elements.

The foregoing descriptions of the disclosure have been presented for purposes of illustration and description. They are not exhaustive and do not limit the disclosure to the precise form disclosed. Modifications and variations are possible in light of the above teachings or may be acquired from practicing of the disclosure. For example, in some implementations, the attributes of the test data available for reservation may be fixed at the data store. In other example implementations, individuals may be able to specify desired test data attributes. The described implementation includes software but may be implemented as a combination of hardware and software or in hardware alone. Additionally, although aspects of the present disclosure are described as being stored in memory, these aspects can also be stored on other types of computer-readable media, such as secondary storage devices, like hard disks, floppy disks, CD-ROM discs, flash memory sticks, and so forth.

What is claimed is:

1. A reservation system for facilitating software testing comprising:
a processing unit;
a data store that stores a set of test data available for testing of a computer program; and
memory that stores computer-readable instructions that, when executed by the processing unit, cause the reservation system to
receive a selection of a portion of the test data from a computing device operated by a first individual, and
reserve the portion of the test data selected such that, while the portion of the test data is reserved, the portion of the test data is modifiable by the first individual and is not modifiable by a second individual.

2. The reservation system of claim 1 wherein:
the portion of the test data reserved for the first individual is modifiable during a first test initiated by the first individual and is not modifiable by a second test initiated by the second individual.

3. The reservation system of claim 1 wherein:
the instructions, when executed by the processing unit, cause the system to
associate the portion of the test data selected with a unique identifier of the first individual in order to reserve the portion of the test data selected for the first individual.

4. The reservation system of claim 1 wherein:
the instructions, when executed by the processing unit, cause the system to
create one or more reservation records in order to reserve the portion of the test data selected for the first individual; and
wherein the one or more reservation records identify the portion of the test data selected and identify the first individual.

5. The reservation system of claim 1 wherein:
the set of test data comprises a set of electronic records; and
individual records in the set of records comprises a set of attributes.

6. The reservation system of claim 5 wherein:
the instructions, when executed by the processing unit, further cause the system to
provide a search interface comprising a set of search criteria that corresponds to the set of attributes to a display device associated with the computing device operated by the first individual,
receive a search query comprising a selection of one or more of the search criteria from the computing device operated by the first individual, and
retrieving one or more records from the data store based on the search query.

7. The reservation system of claim 6 wherein:
the selection of the portion of the test data comprises a selection of one or more of the records retrieved from the data store based on the search query.

8. The reservation system of claim 6 wherein:
the instructions, when executed by the processing unit, further cause the system to
store the search query, and
associate the search query with the first individual.

9. The reservation system of claim 5 wherein:
the records are financial account records; and
the set of attributes comprise at least one attribute selected from the group consisting of a testing environment, an account number, an account classification, an account feature, an account balance, and combinations thereof.

10. The reservation system of claim 1 wherein:
the instructions, when executed by the processing unit, further cause the system to
retrieve updated test data from one or more data stores located remotely relative to the data store, and
update the test data stored at the data store based on the updated test data retrieved.

11. A computer-implemented method for facilitating software testing comprising:
storing, at a data store, a set of test data available for testing of a computer program;
receiving, from a computing device operated by a first individual, a selection of a portion of the test data; and
reserving, using a reservation device, the portion of the test data selected such that, while the portion of the test data is reserved, the portion of the test data is modifiable by the first individual and is not modifiable by a second individual.

12. The method of claim 11 wherein reserving the portion of the test data selected includes:
permitting, using the reservation device, modification of the test data selected during a first test initiated by the first individual; and
restricting, using the reservation device, modification of the test data selected during a second test initiated by the second individual.

13. The method of claim 11 wherein reserving the portion of the test data includes:
associating, using the reservation device, the portion of the test data selected with a unique identifier of the first individual.

14. The method of claim 11 wherein reserving the portion of the test data includes:
creating, using the reservation device, one or more reservation records that identify the portion of the test data selected and that identify the first individual.

15. The method of claim 11 further comprising:
providing, to a display device associated with the computing device operated by the first individual, a search interface that comprises a set of search criteria available for selection;
receiving, at the reservation device from the computing device, a search query that comprises a selection of one or more of the search criteria;
retrieving, using the reservation device, one or more records from the data store based on the search query; and
receiving, at the reservation device from the computing device, a selection of one or more of the records retrieved from the data store;
wherein the portion of the test data selected comprises the one or more records selected.

16. The method of claim 11 further comprising:
receiving, at the reservation device from the computing device operated by the first individual, a reservation duration for the portion of the test data selected.

17. The method of claim 16 further comprising:
providing, using the reservation device, an expiration notification to the first individual at a predetermined amount of time prior to expiration of the reservation duration.

18. The method of claim 16 further comprising:
releasing, automatically using the reservation device, the portion of the test data selected upon expiration of the reservation duration such that the portion of the test data is subsequently reservable.

19. The method of claim 16 further comprising:
receiving, at the reservation device from the computing device operated by the first individual, a renewal request; and
renewing, using the reservation device, reservation of the portion of the test data selected responsive to receipt of the renewal request.

20. The method of claim 11 further comprising:
providing, to a display device associated with the computing device operated by the first individual, a reservation summary interface that comprises a listing of at least one portion of the set of test data that has been reserved for the first individual.
